(19) United States
(12) Patent Application Publication
(10) Pub. No.: US 2001/0035848 A1
(43) Pub. Date: Nov. 1, 2001

(54) Display device

(76) Inventors: Mark Thomas Johnson, Eindhoven (NL); Iain Mcintosh Hunter, Brighton (GB); Edward Willem Albert Young, Eindhoven (NL); Adrianus Sempel, Eindhoven (NL)

Correspondence Address: U.S. Philips Corporation, 580 White Plains Road, Tarrytown, NY, 10591, US

(21) Appl. No.: 09/804,021

(22) Filed: Mar. 12, 2001

(30) Foreign Application Priority Data
Mar. 14, 2000 (EP) 00200921.5

(51) Int. Cl. G09G 3/30

(52) U.S. Cl. 345/76

(57) ABSTRACT

In a LED display, photosensors (14) are added to the (periphery of the) display (1) to detect ambient light, and means (20) are provided to compensate for this by adjusting drive signals.

The invention relates to a display device comprising electroluminescent pixels and a drive element comprising means for providing the pixels with the desired adjustments, and correction means for correcting the adjustments in dependence upon the age of the display device.

Such display devices based on electroluminescence are increasingly based on (polymer) semiconducting organic materials. The display devices may luminesce either via segmented pixels (or solid patterns) but also a display by means of a matrix pattern is possible. The adjustment of the pixels defines the intensity of the light to be emitted by the pixels. Said adjustment may take place via passive or active drive (extra switching elements).

Suitable fields of application of the display devices are, for example, mobile telephones, organizers, etc.

A display device of the type mentioned in the opening paragraph is described in EP 0 923 067. Said document describes the problem of ageing of such a display device. One of the measures proposed in this document for counteracting the effect of ageing (changing voltage/current characteristic, change of light effectiveness) is the provision of a photosensitive diode (photodetector or photosensor) in which the light emitted by an electroluminescent diode (pixel) generates a photocurrent. The photocurrent generated in the photosensitive diode is used as a feedback parameter for correcting the voltage across the electroluminescent diode.

A problem is that not only current is generated due to light emitted by the electroluminescent diode(s) in said photosensor, but that this photosensor also starts conveying current due to incident ambient light. The ambient light will raise this current independent of ageing, while also the feedback aims at raising the current through the electroluminescent diode in the case of a decrease (caused by ageing) of the photocurrent. As a result of the same feedback at higher currents, the display device will start conveying too low currents through the electroluminescent diode(s) (insufficiently luminous display) due to an increase of ambient light. When decreasing the ambient light and hence decreasing the photocurrent, the current through the diodes will increase independently of ageing, which is not only at the expense of extra dissipation but also accelerates ageing. Without special measures, said feedback has a counter-productive effect in this case.

It is, inter alia, an object of the present invention to provide a solution to the above-mentioned problem. It is another object of the invention to utilize this solution, if possible, for improving the functionality of the display device, so that its possibilities of use are increased.

To this end, a display device according to the invention is characterized in that the correction means comprise at least one reference photosensor.

By means of this reference photosensor (for example, a photodiode, photoresistor or another suitable element), the ambient light is measured, for example, prior to the “real display” of images. Dependent on the measured quantity of light, the adjustments of the electroluminescent diode(s) are corrected. The ambient light (or a photocurrent generated thereby) thus functions as a reference.

The reference photosensor is preferably shielded from radiation to be emitted by electroluminescent pixels. In this case, a continuous adaptation to the ambient light is possible.

It is to be noted in this respect that it is known per se from WO 99/53472 to provide an extra photodetector for measuring ambient light, but here again the intensity (luminance) of the display device is raised with an increase of the ambient light. The detrimental consequences have been described above.

A preferred embodiment of a display device according to the invention is characterized in that the correction means comprise a plurality of reference photosensors. Said correction is then determined, for example, with reference to the average value of the measured ambient light. This correction may be alternatively realized locally (for example, in a proximate part of the display device). When determining the average value of the ambient light, a strongly deviating value (for example, in a combined use with a fingerprint sensor, with a finger touching the photodetector during measurement) can be ignored. If necessary, the drive element is then provided with means for performing computing operations on photocurrent (parameter) values obtained via the reference photosensors. The computing operations may also be performed in a further functional unit of which the reference photosensors form part. Applications in, for example, fingerprint sensors, touch screens, document scanners and combined applications with CCDs are feasible. Said further functional unit may be detachable, if necessary.

These and other aspects of the invention are apparent from and will be elucidated with reference to the embodiments described hereinafter.

In the drawings:

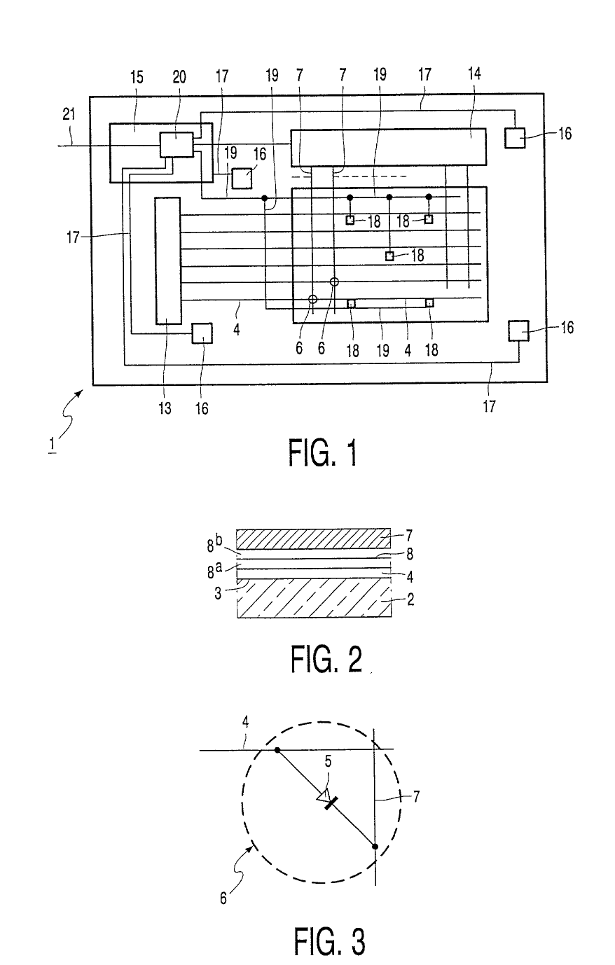

FIG. 1 is a diagrammatic plan view of a part of a display device according to the invention,

FIG. 2 is a diagrammatic cross-section of a part of a pixel, while

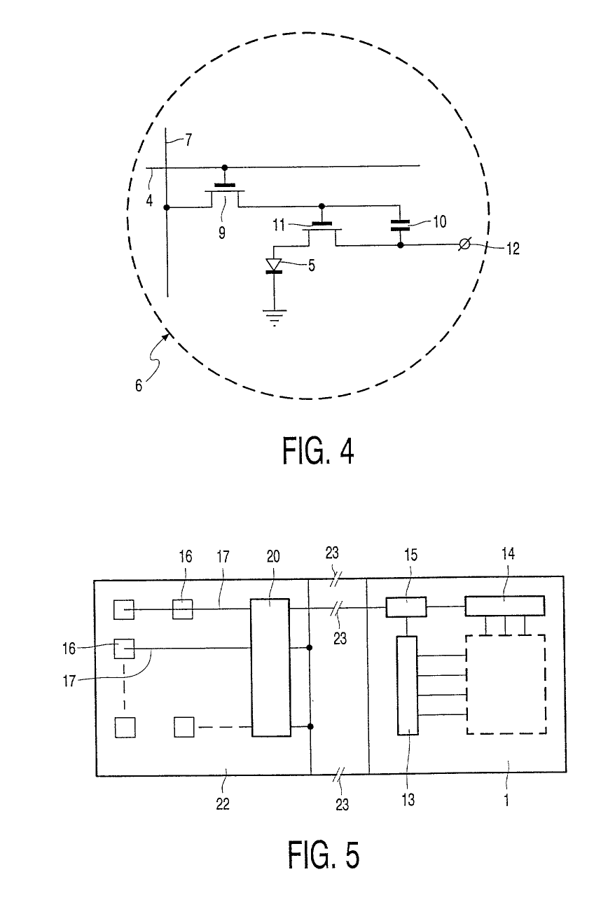

FIGS. 3 and 4 show diagrammatically electrical equivalents of pixels, and

FIG. 5 shows diagrammatically an application of a display device according to the invention.

The Figures are diagrammatic and not drawn to scale. Corresponding components are generally denoted by the same reference numerals.

FIG. 1 is a diagrammatic plan view and FIG. 1 is a diagrammatic cross-section of a part of a display device 1. This device (FIG. 2) comprises a transparent substrate 2 of, for example, glass, a surface 3 of which is provided at the area of a light-emitting diode with a first, transparent electrode layer 4, in this example a conventional, about 150 nm thick, structured layer of ITO (indium tin oxide). The ITO electrodes define parts of pixels 6 at the area of pixels 6 (FIG. 1) and, in the case of passive drive, for example, column tracks 4. If necessary, the tracks 4 are coated at suitable areas with a layer of low-ohmic material. The first electrode layer 4 is provided with a layer of electroluminescent material 8, for example, semiconducting organic electroluminescent material. In this example, the layer 8 is composed of two sub-layers 8^{a}, 8^{b} of, for example, poly(p-phenylene vinylene) or PPV and polyethylene dioxythiophene (PEDOT), respectively. The layer of electroluminescent material is provided with a second electrode layer 7 which, in the case of passive drive, forms part of a pattern of row electrodes (FIG. 1). The electrode layers 4, 7 and the electroluminescent material 8 in between jointly constitute a light-emitting diode or LED, in which, for example, the ITO layer 4 functions as an anode contact, while the electrode layer 7 functions as a cathode contact (a diagrammatic electric equivalent circuit diagram for one pixel is shown in FIG. 3; the light-emitting diode is denoted by reference numeral 5). In the plan view of FIG. 1, parts of the ITO tracks 4 extending horizontally between the pixels 6 (shown diagrammatically) form, for example, row electrodes, while column electrodes are formed by vertically extending metal electrodes 7.

During selection, a row electrode receives a sufficiently negative voltage so that the current source-controlled LEDs within the same row have the desired current feedthrough.

The LEDs may also form part of an active matrix, in which selection takes place again via selection or row electrodes 4, while information is presented via column or data electrodes 7 (a diagrammatic electric equivalent circuit diagram for one pixel is now shown in FIG. 4; the light-emitting diode is again denoted by reference numeral 5). During selection, a capacitance 10 is charged via a TFT transistor 9, in dependence upon the information to be displayed. The charge across the capacitance 10 defines the current through the transistor 11 and the light-emitting diode 5, also in dependence upon the voltage at connection point 12. At the end of the selection period, the capacitance 10 receives, for example, such a charge that the transistor 11 is not turned on so that also the diode 5 does not conduct (does not emit light).

In the display device with display elements as shown in FIG. 3 or 4, the separate row electrodes 4 are activated by means of an address register 13, for example, a shift register or multiplex unit, while information to be displayed is presented to the column electrodes 7 via a shift register or data register 14. Mutual synchronization takes place via the control unit 15 shown diagrammatically. Further elements of the matrix associated with the control unit (notably extra transistors for switching on and off in the active matrix) are not shown in FIGS. 1-3.

As described in the opening paragraph, such display devices are often equipped with one (or more) light-sensitive diode(s) 18 (photodetector or photosensor), in which the light emitted by an electroluminescent diode (pixel) generates a photocurrent. The photocurrent generated in the photosensitive diodes is used as a feedback parameter for correcting the voltage across the electroluminescent diode. These are shown diagrammatically in FIG. 1. Although the measurement of the photocurrent may also be effected via the registers 13, 14, dependent on the realization of the display device, this is shown in a simplified form in the display device of FIG. 1 by means of measuring lines 19 which are connected to the control unit 15. The intensity of the light emitted by the diodes 5 is compared via these photosensitive diodes in the control unit 15 with the value to be adjusted. In the case of a too large deviation, the adjustment of, for example, the data voltage in register 14 is corrected in such a way that the light is emitted in the desired intensity. The ambient light may then disturb the actual measurement.

According to the invention, extra reference photosensors 16 (for example, photodiodes, photoresistors or other suitable elements) are provided in the display device 1 so as to eliminate this disturbance. The light emitted by the diodes 5 is not incident on these reference photosensors 16 (photodiodes in this example), for example, because there is a barrier of light between the photosensors and the actual display section (the matrix 4). In the relevant embodiment, the reference photosensors 16 are sufficiently far remote from the matrix 4 so that the light emitted by the diodes 5 does not generate a photocurrent in the photodiodes 16. In this way, the ambient light is measured separately and can be corrected in the control unit 15. To this end, the control unit 15 is provided with a computing unit 20, for example, a look-up table in which the values to be presented (in a digital or analog form) to the data register 14 is determined by the value of an input signal on the information line 21 and by the information coming from the reference photosensors 16 via the lines 17. The computing unit may be formed in different manners. The ambient light is measured, for example, prior to the “real display” of images. Dependent on the measured quantity of light, the adjustments of the electroluminescent diode(s) are corrected. Usually, one photodiode 16 is sufficient for this measurement. The ambient light (or a photocurrent generated thereby) thus functions as a reference in this case. The display device preferably comprises a plurality of reference photosensors 16. For said correction, the average value of the measured ambient light is then determined in the computing unit 20. When determining the average value of the ambient light, a strongly deviating value (for example, in a combined use with a fingerprint sensor, in which a finger touches the photodetector during the measurement) can be ignored.

FIG. 5 is a diagrammatic plan view of a display device 1 which is coupled (fixedly or not fixedly) to a further functional unit 22 of which the reference photosensors 14 form part. Examples are fingerprint sensors, touch screens and document scanners. The use of CCD sensors is also possible, in which one or more CCD elements function as reference photosensors. The computing operations are performed in a computing unit 20 again, which now forms part of the (detachable) functional unit 22. The other reference numerals denote the same parts as in the previous embodiments. The reference numerals 23 denote broken lines and indicate that the connection between the display device 1 and the further functional unit 22 may be interrupted only electrically (electronically) or both mechanically and electrically.

The invention is of course not limited to the embodiments shown, but several variations are possible within the scope of the invention. For example, if the functional unit 22 consists of a matrix of photosensitive elements, for example, a lens system may be added to this unit so that one (or more) documents (photos) can be stored.

The protective scope of the invention is not limited to the embodiments described. The invention resides in each and every novel characteristic feature and each and every combination of features. Reference numerals in the claims do not limit their protective scope. The use of the verb “to comprise” and its conjugations does not exclude the presence of elements other than those stated in the claims. The use of the article “a” or “an” preceding an element does not exclude the presence of a plurality of such elements.

1. A display device comprising electroluminescent pixels and a drive element comprising means for providing the pixels with the desired adjustments, and correction means for correcting the adjustments in dependence upon the age of the display device, characterized in that the correction means comprise at least one reference photosensor.

2. A display device as claimed in claim 1, characterized in that the reference photosensor is shielded from radiation to be emitted by electroluminescent pixels.

3. A display device as claimed in claim 1, characterized in that the correction means comprise a plurality of reference photosensors.

4. A display device as claimed in claim 3, characterized in that the drive element comprises means for performing computing operations on photocurrent (parameter) values obtained via the reference photosensors.

5. A display device as claimed in claim 3, characterized in that said device comprises a further functional unit of which the reference photosensors form part.

6. A display device as claimed in claim 5, characterized in that the further functional unit is at least temporarily detachable from the display device.

7. A display device as claimed in claim 1, characterized in that the pixels are arranged in the form of a matrix.

8. A display device as claimed in claim 7, characterized in that the pixels are connected to row or column electrodes via switches.
